(19) United States
(12) Patent Application Publication
(10) Pub. No.: US 2022/0235600 A1
(43) Pub. Date: Jul. 28, 2022

(54) BLENDED WOOD INTERIOR DOOR STOPS AND INTERIOR TRIM MOLDINGS

(71) Applicant: William-MacRae and Company, Omaha, NE (US)

(72) Inventor: Colin MacRae Thomson, Issaquah, WA (US)

(21) Appl. No.: 17/585,801

(22) Filed: Jan. 27, 2022

Related U.S. Application Data
(60) Provisional application No. 63/142,090, filed on Jan. 27, 2021.

(51) Int. Cl. E06B 1/04; B32B 21/04; B32B 21/13; B32B 21/02; B32B 7/12; B32B 37/12

(52) U.S. Cl. CPC E06B 1/045; B32B 21/042; B32B 21/13; B32B 21/02; B32B 2262/067; B32B 37/12; B32B 2419/00; B32B 2250/02; B32B 7/12

(57) ABSTRACT

A blended wood interior trim molding assembly (e.g., a blended wood interior door stop assembly) can include a first layer of engineered wood material having a first, generally rectangular cross-sectional thickness, and a second layer of wood material having a second, generally rectangular cross-sectional thickness. The second layer of wood material is joined to the first layer of engineered wood material at a planar interface. Together, the first layer of engineered wood material and the second layer of wood material have a total thickness, with the second, generally rectangular cross-sectional thickness being greater than or equal to at least about fifteen percent (15%) of the total thickness of the first layer of engineered wood material and the second layer of wood material.

### CROSS-REFERENCE TO RELATED APPLICATIONS

The present application claims the benefit under 35 U.S.C. § 119(e) of U.S. Provisional Application Ser. No. 63/142,090, filed Jan. 27, 2021, and titled “BLENDED WOOD INTERIOR DOOR STOPS AND INTERIOR TRIM MOLDINGS,” which is herein incorporated by reference in its entirety.

### BACKGROUND

Interior woodwork for buildings, such as residential and commercial housing, includes trim moldings, such as casings used to trim the perimeter of windows, doors, and so forth. For example, a doorframe can include case molding in the form of two upright jambs. A door can be hung on one of the upright jambs. Door stops in the form of, for example, thin strips of wood, can be mounted along the length of the jambs to limit the swing of the door.

### DRAWINGS

The Detailed Description is described with reference to the accompanying figures. The use of the same reference numbers in different instances in the description and the figures may indicate similar or identical items.

FIG. 1 is a partial isometric view illustrating an interior door stop in accordance with example embodiments of the present disclosure.

FIG. 2 is another partial isometric view of the interior door stop illustrated in FIG. 1.

FIG. 3 is a top plan view of the interior door stop illustrated in FIG. 1.

FIG. 4 is a bottom plan view of the interior door stop illustrated in FIG. 1.

FIG. 5 is a partial front elevation view of the interior door stop illustrated in FIG. 1.

FIG. 6 is a partial rear elevation view of the interior door stop illustrated in FIG. 1.

FIG. 7 is a partial left side elevation view of the interior door stop illustrated in FIG. 1.

FIG. 8 is a partial right side elevation view of the interior door stop illustrated in FIG. 1.

FIG. 9 is an environmental isometric view of the interior door stop illustrated in FIG. 1, where the interior door stop is installed with a door jamb set.

FIG. 10 is a partial isometric view illustrating another interior door stop in accordance with example embodiments of the present disclosure.

FIG. 11 is another partial isometric view of the interior door stop illustrated in FIG. 10.

FIG. 12 is a top plan view of the interior door stop illustrated in FIG. 10.

FIG. 13 is a bottom plan view of the interior door stop illustrated in FIG. 10.

FIG. 14 is a partial front elevation view of the interior door stop illustrated in FIG. 10.

FIG. 15 is a partial rear elevation view of the interior door stop illustrated in FIG. 10.

FIG. 16 is a partial left side elevation view of the interior door stop illustrated in FIG. 10.

FIG. 17 is a partial right side elevation view of the interior door stop illustrated in FIG. 10.

FIG. 18 is an environmental isometric view of the interior door stop illustrated in FIG. 10, where the interior door stop is installed with a door jamb set.

FIG. 19 is a bottom plan view illustrating another interior door stop in accordance with example embodiments of the present disclosure, where the interior door stop has a traditional-shaped end profile.

FIG. 20 is a bottom plan view illustrating a further interior door stop in accordance with example embodiments of the present disclosure, where the interior door stop has a colonial-shaped end profile.

FIG. 21 is a bottom plan view illustrating another interior door stop in accordance with example embodiments of the present disclosure, where the interior door stop has a traditional-shaped end profile.

FIG. 22 is a bottom plan view illustrating a further interior door stop in accordance with example embodiments of the present disclosure, where the interior door stop has a colonial-shaped end profile.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. The following detailed description is, therefore, not to be taken in a limiting sense.

Interior millwork for residential and commercial housing are decorative, nonstructural components normally made of strips of wood and used to cover transition areas between surfaces. These components, called “mouldings” or “moldings,” include casings/case moldings, base moldings, and crown moldings, and can be used to trim the perimeter of windows, doors, and locations where walls meet a floor or a ceiling. Vertical and horizontal millwork trim pieces that cover door openings are called door jambs. Vertical door jambs bear the weight of the door through applied hinges and latches. Two vertical jamb sides and a head jamb may be referred to as a door jamb set. A door jamb set hinged to a door may be referred to as a prehung door. The accuracy of the plumb and strength of a door jamb is important to the overall operational durability and security of a door. Today, millwork also encompasses items that are made using alternatives to wood, including synthetics, plastics, and wood-adhesive composites. Millwork may be painted or stained (e.g., after installation).

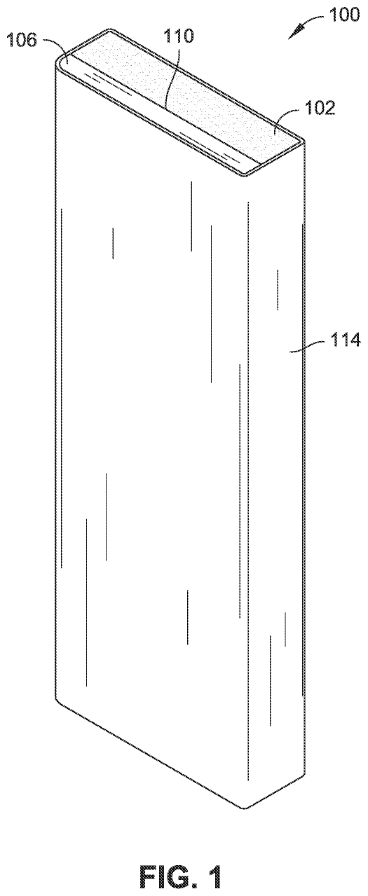

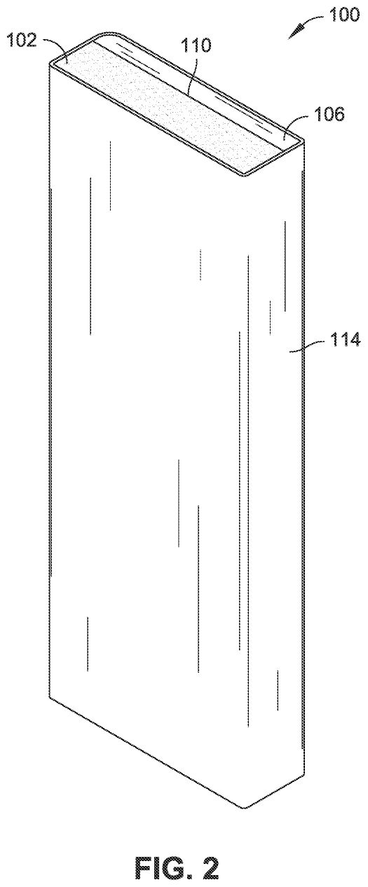

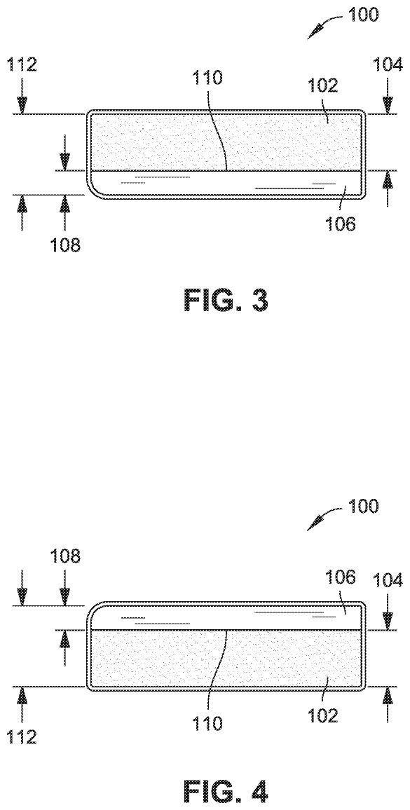

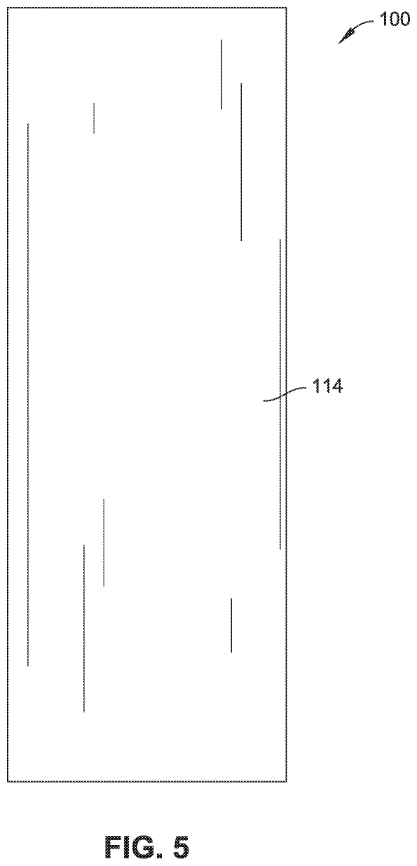

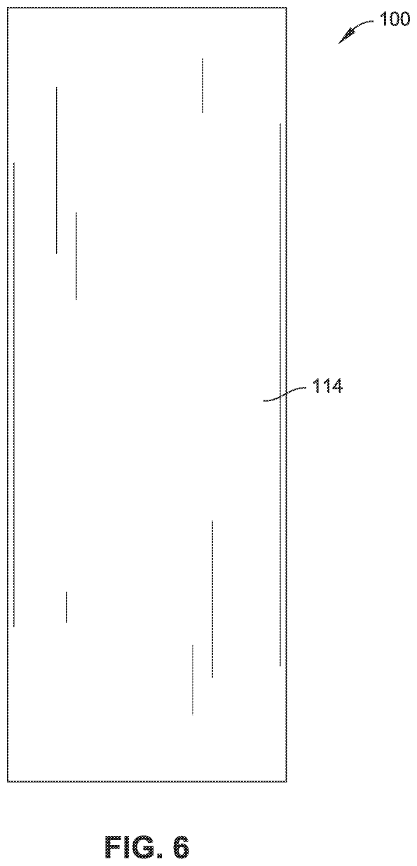

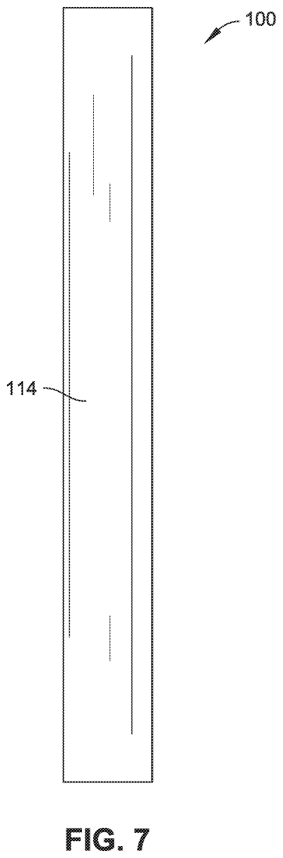

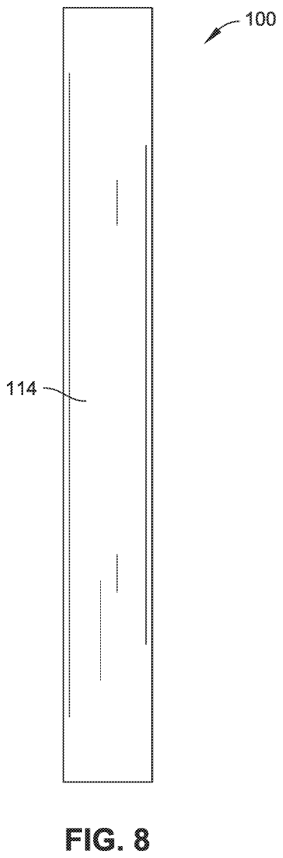

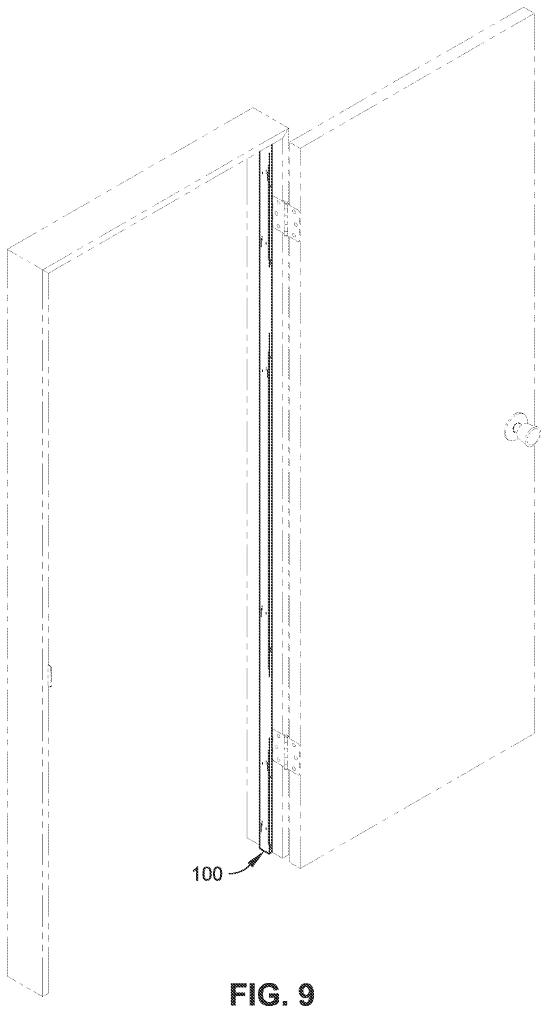

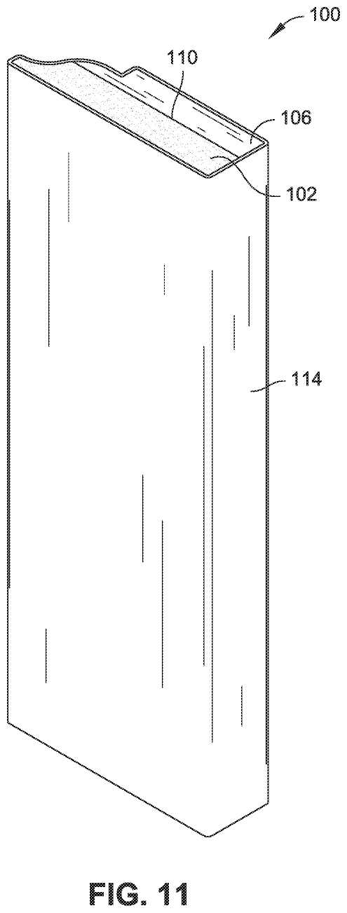

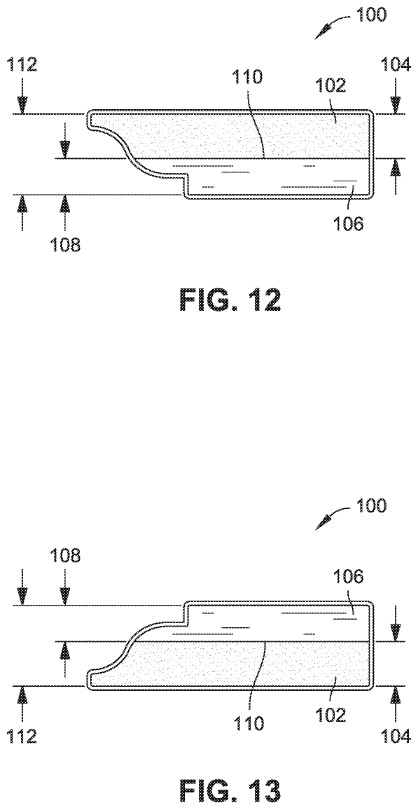

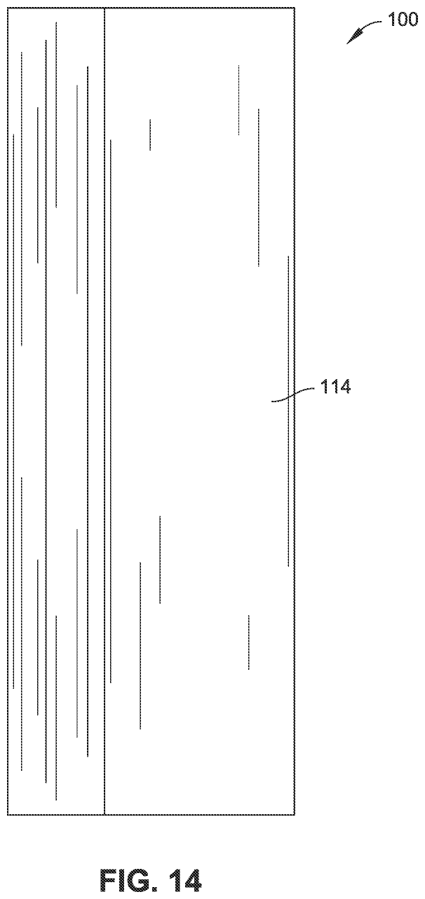

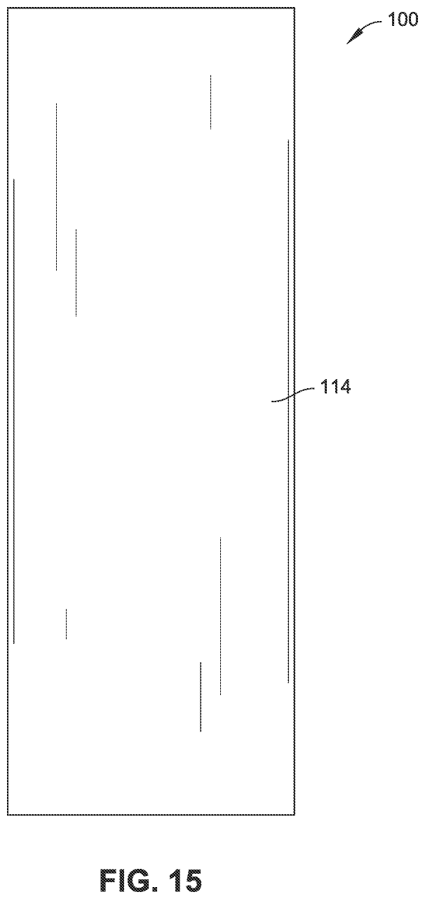

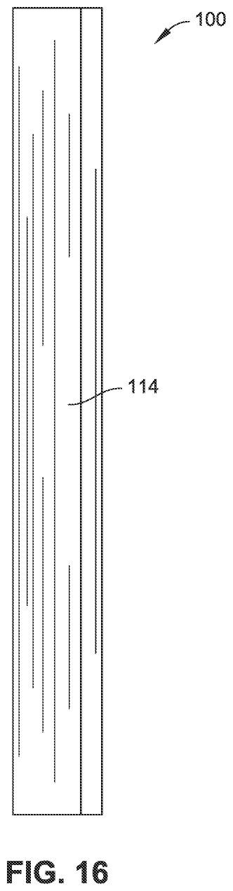

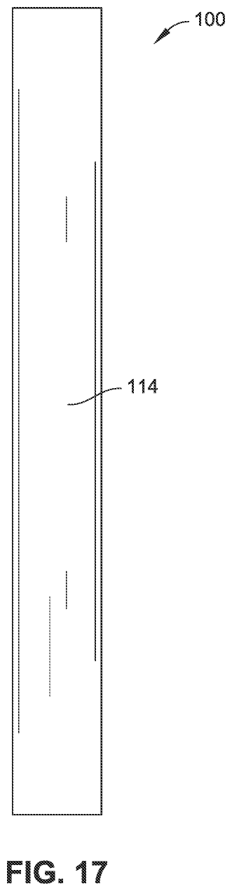

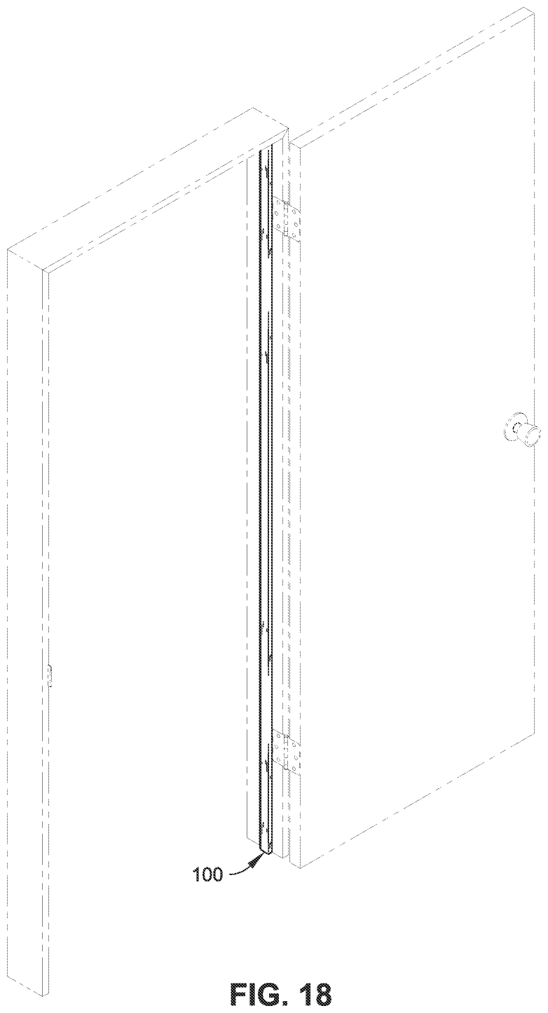

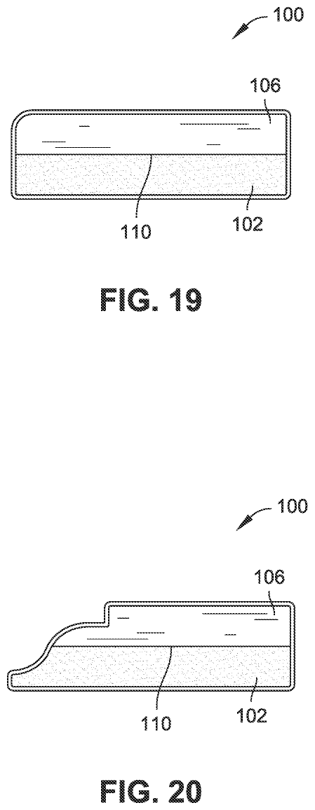

Referring generally to FIGS. 1 through 22, blended wood interior trim molding assemblies, such as door stop assemblies 100 for a door jamb set are described. A door stop assembly 100 can include a first layer 102 of engineered wood material having a first, generally rectangular cross-sectional thickness 104, and a second layer 106 of wood material having a second, generally rectangular cross-sectional thickness 108. In embodiments of the disclosure, the second layer 106 is connected (e.g., bonded, joined) to the first layer 102 at a planar interface 110. Together, the first layer 102 and the second layer 106 have a total thickness 112. As described herein, the second, generally rectangular cross-sectional thickness 104 may be greater than or equal to at least about thirty (30%) of the total thickness 112 of the first layer 102 and the second layer 106. In some embodiments, the second, generally rectangular cross-sectional thickness 104 can be greater than or equal to about forty percent (40%) of the total thickness 112. For instance, the second, generally rectangular cross-sectional thickness 104 can be greater than about sixty percent (60%) of the total thickness 112.

In some embodiments, the second layer 106 of wood material is glued (e.g., using an adhesive binder or another adhesive) to the first layer 102 of engineered wood material at the planar interface 110. A press or other equipment may be used to force the first and second layers 102 and 106 together during the gluing process. In some embodiments, the first layer 102 of engineered wood material can be medium-density fiberboard (MDF), fiberboard, hardboard, particle board, wafer board, oriented strand board, and/or other engineered wood panel materials. The first layer 102 of engineered wood material can be formed by combining at least about eighty percent (80%) cellulosic wood, grass, or other ligneous materials of irregular size and shape, such as fibers, shavings, chips, dust and shavings, whether or not agglomerated with glue or other binding substances.

In some embodiments, the second layer 106 of wood material can be laminated lumber, e.g., laminated veneer lumber (LVL). The second layer 106 of wood material can also be milled lumber material (e.g., pine wood). In some embodiments, the second layer 106 of wood material can include multiple segments fastened together (e.g., finger-jointed wood), particle board, fiberboard, and so forth. As described herein, the second layer 106 of wood material has superior nail holding ability to the first layer 102 of engineered wood material, and/or is more capable of securing staples and/or other fasteners, such as screws, that connect the door stop assembly 100 to, for example, a door jamb. For example, when an engineered wood material is used for a door stop, dimples may appear where nails enter the engineered wood surface (e.g., due to the comparatively higher density of the engineered wood and its correspondingly decreased compressibility).

Additionally, in the case of a milled lumber second layer 106, a first layer 102 of MDF may provide added dimensional stability to the door stop assembly 100, e.g., lessening warp and/or twist found in all-wood jambs. This added dimensional stability can be used to counter dimensional variability associated with solid-wood products, which can result from seasonal moisture content variations, for example. The second layer 106 of wood material may provide increase rigidity to reduce the appearance of waviness after installation of the door stop assembly 100. The rigidity of the second layer 106 of wood material may also strengthen the door stop assembly 100 (e.g., as compared to a door stop constructed fully of engineered wood). Because of the presence of the first layer 102 of engineered wood material, the cost of the door stop assembly 100 may be less than the cost of a comparably sized all-wood stop. Additionally, because of the presence of the second layer 106 of wood material, the door stop assembly 100 may be lighter than a comparably sized stop constructed solely of engineered wood. Further, the second layer 106 of wood material on the face of a door stop assembly 100 or trim molding as described herein may more readily accept paint than engineered wood, providing a superior surface finish.

In some embodiments, the first layer 102 of engineered wood material can be MDF formed from a panel having a thickness of about six millimeters (6 mm) and the second layer 106 of wood material can be LVL and/or finger-jointed pine wood formed from a panel or panels having a thickness of about four millimeters (4 mm). The thicknesses of six millimeters (6 mm) and four millimeters (4 mm) for the first and second layers 102 and 106, respectively, are provided by way of example and are not meant to limit the present disclosure. For example, the first layer 102 can have a thickness between about four millimeters (4 mm) and about eight millimeters (8 mm), and the second layer 106 can have a thickness between about three millimeters (3 mm) and about seven millimeters (7 mm).

After the first and second layers 102 and 106 are adhered together (e.g., as panels), one or more coatings of primer 114 can be applied to the assembled panels. In some embodiments, assembled panels can be cut (e.g., into strips) to form the door stop assemblies 100. For example, assembled, laminated panels can be cut (e.g., ripped) into strips between about twenty-five millimeters (25 mm) wide and about two hundred millimeters (200 mm) wide. Next, the strips may be run through a wood molder to form a shaped door stop and/or trim molding and coated with primer 114. It will be appreciated that the second layer 106 of wood material may mill more smoothly than the first layer 102 of engineered wood material. By way of example, a process for laminating the first layer 102 of engineered wood material and the second layer 106 of wood material together can include cleaning both surfaces of dust and debris, e.g., at surfaces that form the planar interface 110. Both surfaces can also be checked to ensure the surfaces to be joined are smooth and free of voids. Then, one or more of the surfaces to be joined can be coated with glue and/or another adhesive, and finally, even pressure can be applied to both materials, e.g., using a press or another pressing device.

As described herein, door stop assemblies 100 can be used for interior doorway applications. For example, a door can be attached to an interior door jamb assembly by hinges fastened to the door jamb assembly by fasteners (e.g., screws) extending into the door jamb assembly. A door jamb assembly can also include other hardware, such as a strike plate and so forth. A door jamb assembly can be fastened to the doorframe by fasteners (e.g., nails) extending through a side of the door jamb assembly and into the framing studs (e.g., jack stud) and/or header of the doorframe. For example, a doorframe may be formed by a king stud and a jack stud on one side of the doorframe (with additional framing studs mirrored on the other side of the doorframe) and a header at the top of the doorframe. The side of the door jamb set formed by a door jamb assembly that attaches the hinges can include hinge cutouts and forms a hinge jamb. In other embodiments, the door jamb assembly does not necessarily include the hinge cutouts. For instance, cutouts may be added during installation of the door. The other side of the door jamb set formed by a door jamb assembly that attaches the strike plate can include a mortise (e.g., for the strike plate) and forms a latch jamb. The top of the door jamb set formed by a door jamb assembly forms a head jamb. The door can include a latch bolt bore for a latch bolt to interface with the strike plate/mortise and a lockset bore. After the door jamb set is anchored to the rough opening, finishes such as drywall and casings can be added to complete the installation. As described herein, the door stop assemblies 100 are configured to be nailed or stapled into the face of a door jamb through the face of the stop.

The first layer 102 of engineered wood material can be formed of a composite material (e.g., engineered wood formed from wood dust (e.g., sawdust), shavings, fibers, fillers, etc.) and shaped. In embodiments of the disclosure, the first layer 102 of engineered wood material can be a flat panel of engineered wood material. For example, in some embodiments, the first layer 102 of engineered wood material can be molded cellulosic fiberboard, which can be formed from a pre-consolidated mat. The pre-consolidated mat can be formed into consolidated medium-density fiberboard (MDF), hardboard, softboard, low-density fiberboard, and so forth. For instance, hardwood and/or softwood residuals can be broken down into fillers or fibers (e.g., using a defibrator or another pulping machine, grinding, explosion hydrolysis, etc.), and the resulting wood fillers or fibers can be formed into a loose mat along with a binding agent and/or resin and/or wax and compressed under high temperature and pressure to form a first layer 102 of engineered wood material.

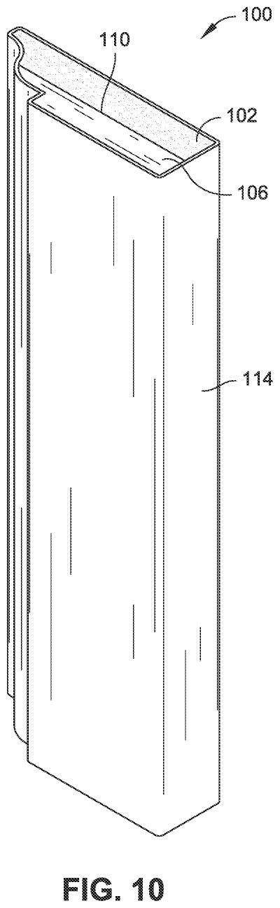

In some embodiments, the pre-consolidated cellulosic mat may be planar. However, when molded to form the first layer 102 of engineered wood material, various shaped molds may be used to form surface features and/or contours (e.g., a decorative shape profile, such as a colonial profile (FIGS. 10 through 18, 20, and 22), a traditional profile (FIG. 1 through 9, 19, and 21), and so forth). In some embodiments, a first layer 102 of engineered wood material may also have one or more smooth exterior surfaces. Further, the edges and/or sides of the door stop assembly 100 may include various edge details. As described, the first layer 102 of engineered wood material may have a generally rectangular cross-sectional thickness.

In some embodiments, the pre-consolidated cellulosic mat can be formed in a wet process, e.g., where cellulosic fillers or fibers in a slurry having a high moisture content (e.g., about ninety percent (90%) water or more by weight) and a synthetic resin binder (e.g., phenol-formaldehyde resin) are deposited onto a water permeable support (e.g., a fine screen, mesh, wire, etc.). Moisture is then removed to leave a wet mat of cellulosic material having a lower moisture content (e.g., about fifty percent (50%) water by weight). The wet mat can then be molded under high temperature and pressure to form the composite first layer 102 of engineered wood material. In some embodiments, the pre-consolidated cellulosic mat can be formed in a wet-dry process, e.g., where a large amount of moisture from a wet mat is evaporated prior to molding (e.g., leaving the mat with a water content of about ten percent (10%) or less by weight). Further, a pre-consolidated cellulosic mat can be formed in a dry process, e.g., where cellulosic fibers are conveyed mechanically or in a gas stream rather than in a liquid. For example, cellulosic fibers may be coated with thermosetting resin binder (e.g., phenol-formaldehyde resin) and formed into a mat by blowing the coated fibers onto a support.

In some embodiments, the first layer 102 of engineered wood material may be formed as a wood composite including lignocellulose/lignocellulosic fiber and a polymer resin. The term lignocellulose refers to plant dry matter (biomass) including carbohydrate polymers (cellulose, hemicellulose) and an aromatic polymer (lignin). The lignocellulose composite mixture may have about 70% to about 99% by weight lignocellulosic fiber. In some embodiments, the density of the first layer 102 may be between about three hundred kilograms per cubic meter (300 kg/m³) and about one thousand six hundred kilograms per cubic meter (1,600 kg/m³). The lignocellulosic fiber can have a range of moisture levels and may be dehydrated prior to treatment with the resin. For example, the lignocellulosic fiber can have from about 2% to about 20% moisture content by weight. In embodiments, the resin may be a formaldehyde-based resin, an isocyanate-based resin, and/or another thermoplastic or thermoset resin. In some embodiments, the amount of resin may range from about 1% to about 25% by weight of the composite. The lignocellulosic composite mixture may also include one or more waxes (e.g., a natural wax and/or a synthetic wax, such as paraffin wax, polyethylene wax, polyoxyethylene wax, microcrystalline wax, shellac wax, ozokerite wax, montan wax, emulsified wax, slack wax, etc.). The composites may also include a pre-press sealer (e.g., a liquid material applied to the surface of a mat used to formulate the composite prior to the mat entering a press). The lignocellulosic mixtures may be pressed into the first layer 102 using flat or molded dies at high temperature and/or pressure. The mixture may initially be formed into a loose mat then placed into a die press.

In some embodiments, a two-part mold, such as a die press (e.g., having a first die and a second die) may be used to form the first layer 102 of engineered wood material. For example, a pre-consolidated mat can be placed into the die press and formed into consolidated medium-density fiberboard (MDF), hardboard, softboard, low-density fiberboard, and so forth. As described, hardwood and/or softwood residuals broken down into fillers or fibers can be formed into a loose mat along with a binding agent and/or resin and/or wax and compressed under high temperature and pressure in the die press to form the first layer 102 of engineered wood material. In some embodiments, one or more walls of the first die and/or the second die may be formed with a negative camber or positive draft (e.g., for more easily releasing from the die press). For example, walls of the first die and/or the second die may slope outwardly and downwardly when viewed from an end, allowing the first layer 102 of engineered wood material to easily release from the dies after formation. In some embodiments, one or more walls of the first die and/or the second die may be formed with a zero camber or zero draft (e.g., at an angle of about ninety (90) degrees from an adjacent surface. In some embodiments, one or more walls of the first die and/or the second die may be formed with a positive camber or negative draft. For example, walls of the first die and/or the second die may slope inwardly and downwardly when viewed from an end, providing a back bevel.

It should be noted that a pre-consolidated cellulosic mat is provided by way of example and is not meant to limit the present disclosure. In other embodiments, a pre-formed planar fiber board may also be molded to form a composite first layer 102 of engineered wood material. For instance, an MDF board may be heat treated to its softening point and then deformed in a press. In some embodiments, a first layer 102 of engineered wood material may also be corrugated (e.g., in the manner of cardboard). When the first layer 102 of engineered wood material is formed (e.g., using a wet process, a wet-dry process, a dry process, a fiber board process, or another process), various surface features and/or contours can be formed in the first layer 102 of engineered wood material using various mold or press features. For example, a first layer 102 of engineered wood material can be formed and textured using a mold or press with a complementary relief pattern that forms a wood grain pattern on one or more surfaces of the first layer 102 of engineered wood material. Additionally, a first layer 102 of engineered wood material can be formed of more than one molded or pressed composite material segment joined together (e.g., using an adhesive binder or another adhesive at contact points along mating surfaces of the engineered wood segments). Further, in some embodiments, a first layer 102 of engineered wood material can be formed using another process, such as extrusion. For example, the first layer 102 of engineered wood material may be formed using one or more extruded plastic materials, vinyl materials, polyvinyl chloride (PVC) materials, fiber glass materials, and so forth. In a similar manner to a molded material that forms a composite first layer 102 of engineered wood material, various surface features and/or contours may be formed in an extruded first layer 102 of engineered wood material (e.g., using various mold and/or press features).

Once the first layer 102 of engineered wood material has been formed under high temperature and pressure, different surface finishes and/or treatments may be applied to the first layer 102 of engineered wood material. For example, one or more layers of primer, paint, and/or stain can be applied to the surface of the first layer 102 of engineered wood material. An interior door stop assembly 100 may be sold as a primed and ready-to-paint unit.

The second layer 106 can be formed of a wood material (e.g., scrap wood), a composite material (e.g., particle board (PB), plywood, laminated veneer lumber (LVL), wafer board, finger-jointed wood, and so forth) having a generally rectangular cross-sectional area. For example, the second layer 106 of wood material can be cut to fit and then glued to the first layer 102 of engineered wood material. In some embodiments, the second layer 106 of wood material can be a wood including, but not necessarily limited to: Radiata Pine, Poplar, Hemlock, Lauan, and so forth. In some embodiments, the density of the second layer 106 may be between about two hundred kilograms per cubic meter (200 kg/m³) and about seven hundred and fifty kilograms per cubic meter (750 kg/m³). In some embodiments, the second layer 106 of wood material can be formed from edge glued blocks, finger jointed blocks, and so forth.

The techniques and apparatus of the present disclosure may provide for improved raw material utilization. For example, wood residuals, particle board, and/or MDF segments used for the second layer 106 of wood material may be milled from smaller sections of wood (e.g., as opposed to typical door stops, which are milled from larger sections of wood). Further, in embodiments where the second layer 106 of wood material has a generally rectangular cross-sectional profile, the second layer 106 of wood material may be cut from a standard thickness flat panel by sawing rather than by milling larger wood sections using, for instance, a molder.

The first layer 102 of engineered wood material can be made from wood fiber and can include small trees that would otherwise be too small to process into typical jambs and stops, as well as including branches, knots, and small and/or short wood scraps. Further, the composite first layer 102 of engineered wood material can be made from tree species not typically used in the manufacturing of door stops (e.g., due to stability issues, size, abundance, and/or other factors). In some embodiments, a door stop can be nailed or stapled into the face of a door jamb through the face of the stop. For example, a door stop assembly 100 may be nailed onto a flat jamb. The holes are then filled prior to finishing (e.g., painting) the door stop assembly 100.

It should also be noted that the surface of a milled door stop assembly 100 can be matched to the surface of, for example, a molded 6-panel door (e.g., having an MDF exterior). For instance, a door stop assembly 100 can have a primer coat applied, which may be similar or comparable to the door mating to the door stop assembly 100. The door stop assembly 100 can also have a surface texture, such as an embossed wood grain pattern or another surface texture, similar to or comparable to the door mating to the door stop assembly 100. Additionally, the incidence of typical wood distortion found in existing wood products, e.g., cupping, warping, twisting, crooking, and so forth, may be reduced or eliminated, e.g., due to the composite first layer 102 of engineered wood material, which can stabilize the second layer 106 of wood material. Further, in some embodiments, the first layer 102 of wood material may include structural features configured to further strengthen a door stop assembly 100 and/or reduce or minimize dimensional distortion/cupping. For example, one or more features, such as longitudinal channels and/or grooves may be formed in the first layer 102 of wood material (e.g., on a back side of the first layer 102 of wood material. In some embodiments, the grooves may run the length of the first layer 102 of wood material.

Additionally, improved utilization of wood and/or reduction of material waste of wood over typical manufacturing may be achieved using the systems, techniques, and apparatus disclosed herein. Also, areas with an abundant wood fiber supply but a lesser supply of larger sections of wood for milling one-piece jamb parts can benefit from the ability to locally manufacture the door stop assemblies 100 disclosed herein, incurring, for example, reduced shipping costs due to domestic production. It should also be noted that the defect rate may be reduced (e.g., in comparison to milling wood components) as described herein.

The shape of the stop or trim may also vary. For example, the stop or trim may be colonial shaped. In some embodiments, a stop or trim may also have square edges. However, these shapes are provided by way of example and are not meant to limit the present disclosure. In other embodiments, a stop or trim may have a different shape, including, but not necessarily limited to: a one-radius edge, a two-radius edge, and so forth. The width and/or height of a stop or trim may also vary. Further, the door stop assembly 100 may have different end work, including, but not necessarily limited to: a straight cut, a miter cut, a coped end cut, and so forth.

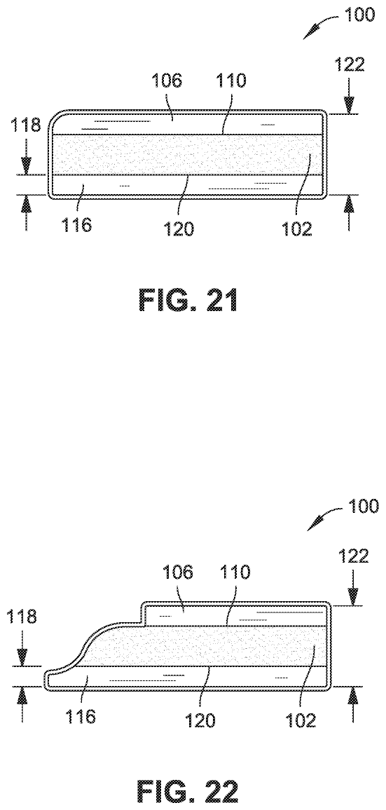

With reference to FIGS. 21 and 22, in some embodiments, a door stop assembly 100 can also have a third layer 116 of wood material having a third, generally rectangular cross-sectional thickness 118. In embodiments of the disclosure, the third layer 116 is connected (e.g., bonded, joined) to the first layer 102 at another planar interface 120 (e.g., opposite the planar interface 110). As previously described with reference to the second layer 106 of wood material, the third layer 116 of wood material can be laminated lumber (e.g., LVL), milled lumber material (e.g., pine wood such as Radiata Pine, Poplar, Hemlock, Lauan), and so forth. In some embodiments, the third layer 116 can be the same or similar material or materials as the second layer 106 and/or can be different wood material(s). In some embodiments, the third layer 116 of wood material can include multiple segments fastened together (e.g., finger-jointed wood), particle board, fiberboard, and so forth. The third layer 116 of wood material can be glued (e.g., using an adhesive binder or another adhesive) to the first layer 102 of engineered wood material at the planar interface 120. A press or other equipment may be used to force the first, second, and third layers 102, 106, and 116 together during the gluing process. By way of example, a process for laminating the first layer 102 of engineered wood material and the second and third layers 106 and 116 of wood material together can include cleaning the surfaces of dust and debris, e.g., at surfaces that form the planar interfaces 110 and 120. The surfaces can also be checked to ensure the surfaces to be joined are smooth and free of voids. Then, one or more of the surfaces to be joined can be coated with glue and/or another adhesive, and finally, even pressure can be applied to both materials, e.g., using a press or another pressing device.

Together, the first layer 102, the second layer 106, and the third layer 116 have a total thickness 122. As described herein, the combined, generally rectangular cross-sectional thicknesses 108 and 118 of the second layer 106 and the third layer 116 may be greater than or equal to at least about thirty percent (30%) of the total thickness 122 of the first layer 102, the second layer 106, and the third layer 116. In some embodiments, the combined, generally rectangular cross-sectional thicknesses 108 and 118 can be greater than or equal to about forty percent (40%) of the total thickness 122. For instance, the combined, generally rectangular cross-sectional thicknesses 108 and 118 can be greater than about sixty percent (60%) of the total thickness 122. In example embodiments where there is a second layer 106 and a third layer 116, the layers 106 and 116 may have at least approximately the same thickness. In other embodiments, the layers 106 and 116 may not necessarily have the same or similar thickness.

While the description herein has detailed door stop assemblies 100 for interior doorway applications with some specificity, it is noted that these particular trim molding applications are provided by way of example and are not meant to limit the present disclosure. In other embodiments, the systems, techniques, and apparatus described herein can be used for various other interior trim molding applications, including, but not necessarily limited to, interior millwork applications such as base moldings, case moldings, crown moldings, quarter-rounds, trim boards, window stools, etc.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A blended wood interior door stop assembly comprising:
a first layer of engineered wood material having a first, generally rectangular cross-sectional thickness; and
at least a second layer of wood material having a second, generally rectangular cross-sectional thickness, the second layer of wood material joined to the first layer of engineered wood material at a planar interface, the first layer of engineered wood material and the second layer of wood material having a total thickness, the second, generally rectangular cross-sectional thickness greater than or equal to at least about fifteen percent (15%) of the total thickness of the first layer of engineered wood material and the second layer of wood material, the second layer of wood material disposed on an outwardly facing side of the blended wood interior door stop assembly where a fastener is to enter the blended wood interior door stop assembly.

2. The blended wood interior door stop assembly as recited in claim 1, wherein the second layer of wood material is glued to the first layer of engineered wood material.

3. The blended wood interior door stop assembly as recited in claim 1, wherein the second, generally rectangular cross-sectional thickness is greater than or equal to at least about twenty percent (20%) of the total thickness of the first layer of engineered wood material and the second layer of wood material.

4. The blended wood interior door stop assembly as recited in claim 1, wherein the first layer of engineered wood material comprises medium-density fiberboard.

5. The blended wood interior door stop assembly as recited in claim 1, wherein the second layer of wood material comprises laminated lumber.

6. The blended wood interior door stop assembly as recited in claim 1, wherein the second layer of wood material comprises milled lumber material.

7. The blended wood interior door stop assembly as recited in claim 1, wherein the second layer of wood material comprises at least one of a plurality of segments fastened together, particle board, or fiberboard.

8. The blended wood interior door stop assembly as recited in claim 1, further comprising a third layer of wood material having a third, generally rectangular cross-sectional thickness, the third layer of wood material joined to the first layer of engineered wood material at a second planar interface opposite the planar interface.

9. A method of forming a blended wood interior door stop assembly, the method comprising:
forming a first layer of engineered wood material having a first, generally rectangular cross-sectional thickness;
forming a second layer of wood material having a second, generally rectangular cross-sectional thickness; and
joining the second layer of wood material to the first layer of engineered wood material at a planar interface, the first layer of engineered wood material and the second layer of wood material having a total thickness, the second, generally rectangular cross-sectional thickness greater than or equal to at least about fifteen percent (15%) of the total thickness of the first layer of engineered wood material and the second layer of wood material, the second layer of wood material disposed on an outwardly facing side of the blended wood interior door stop assembly where a fastener is to enter the blended wood interior door stop assembly.

10. The method as recited in claim 9, wherein the second layer of wood material is glued to the first layer of engineered wood material.

11. The method as recited in claim 9, wherein the second, generally rectangular cross-sectional thickness is greater than or equal to at least about twenty percent (20%) of the total thickness of the first layer of engineered wood material and the second layer of wood material.

12. The method as recited in claim 9, wherein the first layer of engineered wood material comprises medium-density fiberboard.

13. The method as recited in claim 9, wherein the second layer of wood material comprises laminated lumber.

14. The method as recited in claim 9, wherein the second layer of wood material comprises milled lumber material.

15. The method as recited in claim 9, wherein the second layer of wood material comprises at least one of a plurality of segments fastened together, particle board, or fiberboard.

16. The method as recited in claim 9, further comprising forming a third layer of wood material having a third, generally rectangular cross-sectional thickness; and
joining the third layer of wood material to the first layer of engineered wood material at a second planar interface opposite the planar interface.

17. A blended wood interior trim molding assembly comprising:
a first layer of engineered wood material having a first, generally rectangular cross-sectional thickness; and
at least a second layer of wood material having a second, generally rectangular cross-sectional thickness, the second layer of wood material joined to the first layer of engineered wood material at a planar interface, the first layer of engineered wood material and the second layer of wood material having a total thickness, the second, generally rectangular cross-sectional thickness greater than or equal to at least about fifteen percent (15%) of the total thickness of the first layer of engineered wood material and the second layer of wood material, the second layer of wood material disposed on an outwardly facing side of the blended wood interior door stop assembly where a fastener is to enter the blended wood interior door stop assembly.

18. The blended wood interior trim molding assembly as recited in claim 17, wherein the second layer of wood material is glued to the first layer of engineered wood material.

19. The blended wood interior trim molding assembly as recited in claim 17, wherein the second, generally rectangular cross-sectional thickness is greater than or equal to at least about twenty percent (20%) of the total thickness of the first layer of engineered wood material and the second layer of wood material.

20. The blended wood interior trim molding assembly as recited in claim 17, further comprising a third layer of wood material having a third, generally rectangular cross-sectional thickness, the third layer of wood material joined to the first layer of engineered wood material at a second planar interface opposite the planar interface.
